(19) United States
(12) Patent Application Publication
(10) Pub. No.: US 2007/0295225 A1
(43) Pub. Date: Dec. 27, 2007

(54) FILLING LEVEL SENSOR DEVICE FOR A RESERVOIR HAVING AN OUTLET FOR SUPPLYING AN ELECTRICALLY CONDUCTIVE FLUID IN A HOUSEHOLD APPLIANCE

(75) Inventor: Wenzel Meierfrankenfeld, Guetersloh (DE)

Correspondence Address: DARBY & DARBY P.C., P.O. BOX 770, Church Street Station, New York, NY, 10008-0770, US

(73) Assignee: Miele & Cie. KG, Guetersloh (DE)

(21) Appl. No.: 11/767,773

(22) Filed: Jun. 25, 2007

(30) Foreign Application Priority Data
Jun. 26, 2006 (DE) 10 2006 029 606.0

(51) Int. Cl. A23C 3/07

(52) U.S. Cl. 99/451

(57) ABSTRACT

A filling level sensor device for an electrically conductive reservoir for supplying an electrically conductive fluid in a household appliance includes an electrical control unit and an electrode. The electrical control unit includes an evaluation circuit, a memory and a power supply. The electrode is connected to the power supply so as to carry a current flow. The electrode is electrically insulated from the reservoir and disposed at least partially in a chamber of the reservoir. The evaluation circuit is configured to compare, to a reference value stored in the memory, a magnitude of the current flow or of a corresponding physical quantity. The power supply is configured to generate an alternating current between the power supply and the electrode. When a filling level of the fluid in the chamber is below a predetermined filling level, the electrode and the reservoir together form a first electrical capacitor, and the reservoir and a grounded portion of the household appliance together form a second electrical capacitor. The grounded portion of the household appliance is grounded via ambient air. The first and second capacitors are electrically connected in series.

Priority is claimed to German Patent Application DE 10 2006 029 606.0, filed Jun. 26, 2006, which is hereby incorporated by reference herein.

The invention relates to a filling level sensor device for a reservoir having an outlet for supplying an electrically conductive fluid in a household appliance, the filling level device having an electric control unit including an evaluation circuit, a memory and a power supply, whereby the reservoir is made of an electrically conductive material or has a coating that is electrically conductive.

### BACKGROUND

A filling level sensor device is described, for example, in German patent application DE 35 41 752 A1. The filling level sensor device comprises an electric control unit having an evaluation circuit, a memory and a power supply. The reservoir is made of an electrically conductive material, whereby an electrode that is connected to the electric power supply so as to carry current and that is electrically insulated from the reservoir is arranged at least partially in its reservoir chamber. In order to determine the filling level, the strength of the current flow or of a corresponding physical quantity can be compared in the evaluation circuit to a reference value stored in the memory. For this purpose, the reservoir has to be electrically connected to the ground.

### SUMMARY

It is thus an aspect of the present invention to provide a filling level sensor device that can be realized with minimal engineering work.

In an embodiment, the present invention provides a filling level sensor device for a reservoir operatively connected to an outlet for supplying an electrically conductive fluid in a household appliance, the reservoir being made of an electrically conductive material or having a coating that is electrically conductive when the filling level sensor device is disposed in an operating position. The filling level sensor device includes an electrical control unit and an electrode. The electrical control unit includes an evaluation circuit, a memory and a power supply. The electrode is connected to the power supply so as to carry a current flow. The electrode is electrically insulated from the reservoir and disposed at least partially in a chamber of the reservoir. The evaluation circuit is configured to compare, to a reference value stored in the memory, a magnitude of the current flow or of a corresponding physical quantity. The power supply is configured to generate an alternating current between the power supply and the electrode. When a filling level of the fluid in the chamber is below a predetermined filling level, the electrode and the reservoir together form a first electrical capacitor, and the reservoir and a grounded portion of the household appliance together form a second electrical capacitor. The grounded portion of the household appliance is grounded via ambient air. The first and second capacitors are electrically connected in series.

### BRIEF DESCRIPTION OF THE DRAWINGS

Embodiments of the invention are shown schematically in the drawings and will be described in greater detail below. The following are shown:

FIG. 1—a household appliance with a filling level sensor device according to the invention in a first embodiment in a rough schematic depiction;

FIG. 2—the filling level sensor device of FIG. 1 in a detailed view in the area of the electrical connection between the electric control unit and the electrode;

FIG. 3—an electric equivalent circuit diagram of the arrangement of FIG. 1; and

FIG. 4—a household appliance with a filling level sensor device according to the invention in a second embodiment in a rough schematic depiction.

### DETAILED DESCRIPTION

Advantages that can be achieved with the invention include the fact that less engineering work is involved to create a filling level sensor device and thus its production is more cost-effective. The filling level sensor device according to the invention makes it possible to monitor, that is to say, to detect, a single filling level, for example, a minimum filling level. In order to monitor several filling levels that differ from each other, a multiple arrangement of the filling level sensor devices according to the invention would be necessary. An electrical connection between the reservoir and the ground is not necessary. Moreover, this makes it possible to design the arrangement of the reservoir and thus of the filling level sensor device more freely, so that the installation space available on or in the household appliance can be used in a more space-saving way.

An advantageous refinement provides that the electrode is configured as part of an inlet or as part of the outlet of the reservoir. In this manner, the filling level sensor device is further simplified in terms of its design and can be made even more cost-effectively.

In an advantageous refinement, the reservoir is configured so that it can be removed from the housing of the household appliance and the current-carrying connection between the electric power supply and the electrode can be automatically established by placing the reservoir into its operating position in which the reservoir is connected at least to the outlet so as to carry fluid. This improves the convenience for the user.

An advantageous refinement of the above-mentioned embodiment provides that when the reservoir is in the operating position, the current-carrying connection is configured as an electrical connection, whereby this connection can be established via corresponding electric contact surfaces of the electrode and of the electric control unit. As a result, the above-mentioned embodiment is realized in an especially simple manner.

Fundamentally, the configuration of the contact surfaces of the above-mentioned electrical connection can be selected over a broad suitable range. Advantageously, the electric contact surface associated with the electric control unit has at least one elevation and is biased by means of a spring element in such a way that, when the reservoir is moved into the operating position, the elevation penetrates partially into the contact surface associated with the electrode. In this manner, a reliable electrical contacting of the two contact surfaces is ensured, even under adverse environmental conditions. For example, it is conceivable that, over the course of time, an electrically insulating coating will be deposited or formed on at least one of the two contact surfaces. Then, when the reservoir is once again moved into its operating position, this coating would be penetrated by the elevation, thus establishing the electrical contact between the two contact surfaces.

In another advantageous refinement of a filling level sensor device according to the invention having a reservoir that can be removed from the household appliance, the current-carrying connection can be established via a coupling capacitor, whereby one plate of the coupling capacitor is conductively connected to the electric control unit while the other plate of the coupling capacitor is conductively connected to the electrode. In this manner, the embodiment of a filling level sensor device having a reservoir that can be removed from the household appliance can be achieved in an especially simple manner.

In an advantageous refinement of the above-mentioned embodiment, the dielectric strength of the coupling capacitor is selected to be so high that the use of electric safety extra-low voltage in the electric control unit is not necessary. In the case of an electrical connection, for safety reasons, it is always necessary to use safety extra-low voltage in the electric control unit. If the dielectric strength of the coupling capacitor is selected high enough, this is no longer necessary. The result of this is a further simplification of the arrangement as well as a cost reduction. The means with which to influence the dielectric strength of the coupling capacitor in the desired manner by taking design measures are well-known to the person skilled in the art.

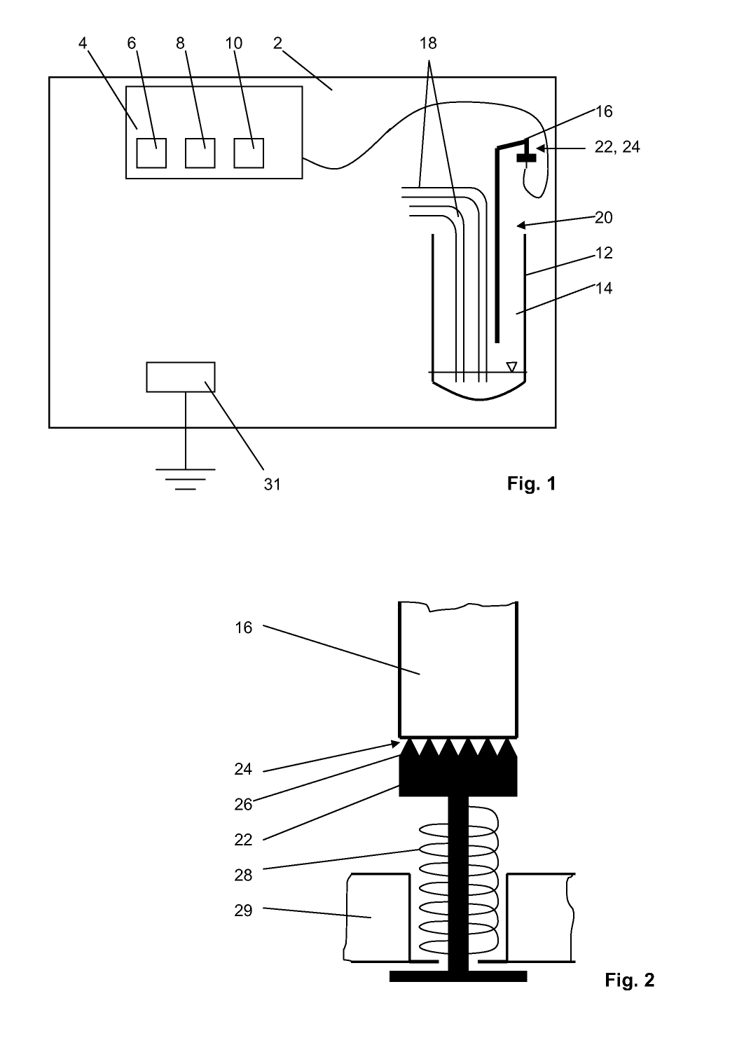

FIG. 1 schematically shows a household appliance 2 configured as a beverage maker having a filling level sensor device according to the invention. The filling level sensor device has an electric control unit 4 having an evaluation circuit 6, a memory 8 and an electric power supply 10, whereby the electric power supply 10 generates an alternating voltage and thus an alternating current. Moreover, the filling level sensor device comprises a reservoir 12 for milk, which is made of stainless steel. As an alternative, it would also be conceivable for the reservoir 12 to be made of another electrically conductive material, for example, aluminum, or for the reservoir 12 to have an electrically conductive coating on the side of its wall facing the reservoir chamber 14.

Moreover, the filling level sensor device according to the invention has an electrode 16 that extends partially into the reservoir chamber 14 and that is electrically insulated from the reservoir 12, said electrode 16 being connected in a current-carrying manner to the electric power supply 10 when the filling level sensor device is in the operating position.

The reservoir 12 in the present embodiment has two outlets 18 configured as milk lines through which the milk held in the reservoir 12 can be fed to the milk dispensers of the beverage maker 2. Here, the reservoir 12 can be filled with milk via an inlet 20 that is configured as an opening. For this purpose, the reservoir 12, which is held inside the beverage maker 2 when the filling level sensor device is in the operating position, is configured so that it can be removed from the beverage maker 2, which will be explained in greater depth below.

As an alternative to this, it would also be possible to design the electrode 16 in combination with one of the outlets 18 so as to allow a further reduction of the components. This is especially easy to achieve if the appertaining outlet 18, for example, for hygienic reasons, is made of steel or of another electrically conductive material.

If the inlet 20 is likewise configured as a milk line, an analogous combination of the electrode 16 with the inlet 20 would also be conceivable.

In the present embodiment, when the reservoir 12, which can be removed from the beverage maker 2, is in its operating position in which the reservoir 12 is connected to the outlets 18 so as to carry fluid, said reservoir 12 is connected via a current-carrying electrical connection to the electric power supply 10 of the electric unit 4. In order to be able to remove the reservoir 12 from the beverage maker 2, a first electric contact surface 22 is in a current-carrying connection with the electric control unit 4 and a second contact surface 24 is in a current-carrying connection with the electrode 16. When the reservoir 12 is attached to the beverage maker 2, that is to say, when it is moved into the operating position shown in FIG. 1, the two contact surfaces 22, 24 are automatically brought into current-carrying contact with each other in a manner generally known to the person skilled in the art.

The configuration of the contact surfaces 22, 24 and their interaction is described in greater detail below with reference to FIG. 2.

As can clearly be seen in FIG. 2, the first contact surface 22 has a plurality of small elevations 26 that reliably ensure the electrical contact between the two contact surfaces 22, 24. For this purpose, in a manner known to the person skilled in the art, the contact surface 22 is biased by means of a spring element 28 upwards in the direction of the drawing plane against a holder 29 arranged on the housing of the beverage maker 2. When the reservoir 12 is moved into its operating position as shown in FIG. 1, the face of the electrode 16, which is configured as a contact surface 24, wipes over the elevations 26 of the contact surface 22, as a result of which said elevations penetrate into the surface of the contact surface 24 owing to the biasing. Through this configuration of the contact surfaces 22, 24, a reliable electrical contacting is ensured, even if the surfaces may have been passivated.

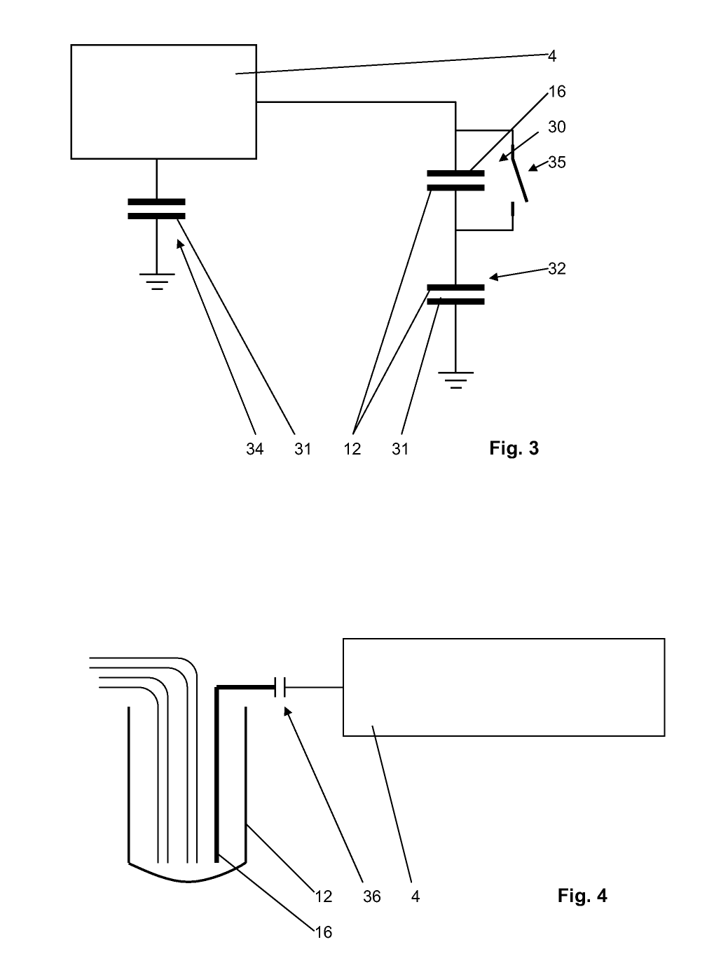

As shown schematically in FIG. 3, when the filling level of milk is below the filling level that is to be detected, that is to say, below the electrode 16, the electrode 16, together with the reservoir 12, forms an electric capacitor 30 having a capacitance c1 and the reservoir 12, together with another grounded household appliance part 31 of the beverage maker 2, forms an electric capacitor 32 with a capacitance c2, whereby the two capacitors 30, 32 are electrically connected in series. Due to the naturally much smaller surface area of the electrode 16 in comparison to the surface area of the reservoir 12, the capacitance c1 is much smaller than the capacitance c2.

The electrode 16, that is to say, one plate of the capacitor 30, is connected via the above-mentioned contact surfaces 22, 24 to the electric control unit 4 so as to carry current when the filling level sensor device is in the operating position, that is to say, when the reservoir 12 is in the operating position. Analogously to the reservoir 12, the electric control unit 4, together with the other household appliance part 31 of the beverage maker 2 that is grounded via the ambient air, forms an electric capacitor 34 having the capacitance c3. The electric control unit 4 and especially the reservoir 12 are held potential-free on the beverage maker 2 when the filling level sensor device is in the operating position. Potential-free means that no electrical ground connection exists, but rather that the electrical ground connection is made exclusively via the ambient air.

The mode of operation of the filling level sensor device according to the invention is explained below in greater detail with reference to FIGS. 1 to 3.

When the reservoir 12 is in the operating position, it is situated inside the beverage maker 2. Since the filling level of the milk held in the reservoir chamber 14, as can be seen in FIG. 1, is below the electrode 16, the electrode 16, the reservoir 12 and the electric control unit 4 form the electric circuit explained above with reference to FIG. 3. The alternating current generated by the electric power supply 10 between the electric power supply 10 and the electrode 16 can be measured and evaluated by the evaluation circuit 6 in a manner known to the person skilled in the art, for example, by means of an electric voltage measurement at a resistor that is electrically connected in parallel. The measured electrical voltage is compared in the evaluation circuit 6 to a reference value stored in the memory 8. As a result of the two series-connected capacitors 30, 32 and the associated high capacitive resistance, only a small alternating current flows, so that the measured voltage value is less that the stored reference value. On a display of the beverage maker 2, the message is displayed to the user that the minimum filling level in the reservoir 12 is too low and that milk has to be added. As an alternative to this, it would also be conceivable for an acoustic signal to be emitted. Moreover, with an inlet 20 configured as a milk line, it would also be possible for the reservoir 12 to be filled automatically via a feed line fitted with a valve.

In the present embodiment, due to the way the machine is designed, the message to the user to fill the reservoir 12 with milk is displayed at a point in time when milk can still be sucked in via the outlets 18. This is achieved in that the outlets 18 extend deeper into the reservoir 12 than the electrode 16. This ensures that no air is sucked in via the outlets 18 and thus conveyed further. In order to achieve the same effect with the above-mentioned alternative in which the electrode 16 and the outlet 18 are configured as one single component, it would be conceivable to place an extension piece made of electrically non-conductive material, for example, a plastic tube, onto the lower end of the outlet 18 that is configured as an electrode. In this manner, the above-mentioned effect is achieved with simple design measures. Of course, the person skilled in the art also has other suitable alternatives available for this purpose.

In response to the displayed message, the user opens a service door of the beverage maker 2 and takes out the reservoir 12 in order to fill it with milk. After the filling procedure, the user moves the reservoir 12 back into the operating position explained above. In this process, an electrical connection is established between the two contact surfaces 22, 24, so that an alternating current can once again flow between the electric power supply 10 and the electrode 16. Since the filling level of the milk in the reservoir 12 is above the lower end of the electrode 16, the capacitor 30 is bridged. This is shown symbolically by a switch 35 in FIG. 3. In case of a filling level above the lower end of the electrode 16, the switch 35 of FIG. 3 is in the closed position. As a result, of the capacitors 30, 32, only the capacitor 32 is still capacitively active, which leads to a reduction of the capacitive resistance and thus to an increase in the alternating current flowing between the electric power supply 10 and the electrode 16. The measured electric voltage is now greater than the stored reference value and the display of the above-mentioned message is automatically extinguished.

FIG. 4 shows a second embodiment of the filling level sensor device according to the invention in which, instead of the electrical connection via the contact surfaces 22, 24, when the removable reservoir 12 is in the operating position, the electrode 16 is connected to the electric power supply 10 by means of a coupling capacitor 36 so as to carry current. Here, one plate of the coupling capacitor 36 is conductively connected to the electric power supply 10 and the other plate is conductively connected to the electrode 16. In this manner, in embodiments with removable reservoirs 12, the filling level sensor device according to the invention can have an even simpler design. Moreover, electrically insulating deposits and layers on the plates of the coupling capacitor 36 would not have a detrimental effect on the detection of the filling level.

If the capacitance of the coupling capacitor 36 is selected to be high enough in a manner known to the person skilled in the art, this second embodiment also offers the advantage that mains voltage can also be used in the electric control unit 4; then, safety extra-low voltage is not absolutely necessary.

The filling level sensor device according to the invention is not limited to the embodiment presented. In addition to detecting milk, the detection of other electrically conductive fluids is also possible. Moreover, the filling level sensor device can also be used in reservoirs that are permanently integrated on or in the household appliance. The higher the frequency of the alternating current that flows between the electric power supply 10 and the electrode 16, the more the electrode 16 functions as a transmitting antenna in case the filling level is lower than the lower end of the electrode 16, or the more the reservoir 12 functions as a transmitting antenna in case the filling level is higher than the lower end of the electrode 16.

What is claimed is:

1. A filling level sensor device for a reservoir operatively connected to an outlet for supplying an electrically conductive fluid in a household appliance, the reservoir being made of an electrically conductive material or having a coating that is electrically conductive when the filling level sensor device is disposed in an operating position, the filling level sensor device comprising:
an electrical control unit including an evaluation circuit, a memory and a power supply; and
an electrode connected to the power supply so as to carry a current flow, the electrode being electrically insulated from the reservoir and disposed at least partially in a chamber of the reservoir;
wherein:
the evaluation circuit is configured to compare, to a reference value stored in the memory, a magnitude of the current flow or of a corresponding physical quantity;
the power supply is configured to generate an alternating current between the power supply and the electrode; and
when a filling level of the fluid in the chamber is below a predetermined filling level, the electrode and the reservoir together form a first electrical capacitor, and the reservoir and a grounded portion of the household appliance together form a second electrical capacitor, the grounded portion of the household appliance being grounded via ambient air, the first and second capacitors being electrically connected in series.

2. The filling level sensor device as recited in claim 1 wherein the electrode is configured as part of an inlet of the reservoir or as part of the outlet of the reservoir.

3. The filling level sensor device as recited in claim 1 wherein the reservoir removable from a housing of the household appliance, and wherein the electrode is connected to the power supply so as to carry the current flow via a current-carrying connection automatically establishable by disposing the reservoir in the operating position so as to connect the reservoir to the outlet for supplying the fluid.

4. The filling level sensor device as recited in claim 2 wherein the reservoir removable from a housing of the household appliance, and wherein the electrode is connected to the power supply so as to carry the current flow via a current-carrying connection automatically establishable by disposing the reservoir in the operating position so as to connect the reservoir to the outlet for supplying the fluid.

5. The filling level sensor device as recited in claim 3 wherein the current-carrying connection is an electrical connection established via a first electrical contact surface of the electrode and a second electrical contact surface of the electrical control unit.

6. The filling level sensor device as recited in claim 4 wherein the current-carrying connection is an electrical connection established via a first electrical contact surface of the electrode and a second electrical contact surface of the electrical control unit.

7. The filling level sensor device as recited in claim 5 wherein the second electrical contact surface includes at least one elevation and is biased via a spring element so that the elevation penetrates partially into the first contact surface when the reservoir is disposed in the operating position.

8. The filling level sensor device as recited in claim 6 wherein the second electrical contact surface includes at least one elevation and is biased via a spring element so that the elevation penetrates partially into the first contact surface when the reservoir is disposed in the operating position.

9. The filling level sensor device as recited in claim 3 further comprising a coupling capacitor, the current-carrying connection being establishable via the coupling capacitor, a first plate of the coupling capacitor being conductively connected to the electrical control unit and a second plate of the coupling capacitor being conductively connected to the electrode.

10. The filling level sensor device as recited in claim 4 further comprising a coupling capacitor, the current-carrying connection being establishable via the coupling capacitor, a first plate of the coupling capacitor being conductively connected to the electrical control unit and a second plate of the coupling capacitor being conductively connected to the electrode.

11. The filling level sensor device as recited in claim 9 wherein the coupling capacitor has a dielectric strength of a magnitude that makes use of a low safety voltage in the electrical control unit unnecessary.

12. The filling level sensor device as recited in claim 10 wherein the coupling capacitor has a dielectric strength of a magnitude that makes use of a low safety voltage in the electrical control unit unnecessary.
